(19) United States
(12) Patent Application Publication
(10) Pub. No.: US 2006/0001007 A1
(43) Pub. Date: Jan. 5, 2006

(54) Spherical light storing phosphor powder and process for producing the same

(75) Inventor: Toshinobu Fukui, Neyagawa-shi (JP)

Correspondence Address: OSHA LIANG L.L.P., 1221 MCKINNEY STREET, SUITE 2800, HOUSTON, TX, 77010, US

(73) Assignees: EZ Bright Corporation, Osaka (JP); Joint Ventrues of China and Japan Wuxi Pax Decorative Products Co., Ltd., Jiangsu (CN)

(21) Appl. No.: 10/517,589

(22) PCT Filed: Jun. 12, 2003
(86) PCT No.: PCT/JP03/07461

§ 371 Date: Jul. 18, 2005

(30) Foreign Application Priority Data
Jun. 13, 2002 (JP) 2002-210287

(51) Int. Cl. C09K 11/08; C09K 11/54; C09K 11/68

(52) U.S. Cl. 252/301.4 F; 252/301.4 R; 252/301.6 R; 252/301.6 F; 252/301.5; 264/15; 264/21

(57) ABSTRACT

An object of the present invention is to provide a light-storing fluorescent spherical powder that exhibits a high emission intensity, emits light for a prolonged time, and has an excellent workability even when it is added to synthetic resin or the like. There is provided a light-storing fluorescent spherical powder that contains an alkaline earth metal aluminate as a main component and a transition metal element such as lanthanoid as an activator, in which the powder comprises a spherical powder. There is further provided a process of manufacturing a light-storing fluorescent spherical powder that includes preparing as a raw material a light-storing fluorescent powder that has been previously synthesized or a light-storing fluorescent precursor powder that has been produced by pre-reaction of a synthetic raw material of a light-storing fluorescent material, and passing the prepared raw material through a region heated to a temperature higher than a melting point of a light-storing fluorescent material, thereby forming the raw material into spherical shape.

### FIELD OF THE INVENTION

The present invention relates to a light-storing fluorescent spherical powder and a process of manufacturing the same.

### BACKGROUND OF THE INVENTION

A light-storing fluorescent material is capable of storing light energy of sunlight or light from a different light source when the light is irradiated thereon, and emitting light for a prolonged period of time in a dark place. This material is applicable to various purposes. Most of the conventional light-storing fluorescent materials are comprised of sulfur compounds; for example, ZnS:Cu.Co or CaS:Co is used. Powders of these light-storing fluorescent materials can store light and emit the same, but the emission time is about 1-2 hours at most, has poor chemical stability and poor durability, and is easy to deteriorate, so that the emission capability thereof is rapidly reduced after a few tens of hours and therefore has a shortcoming in that the time for which the powder is used is shortened.

A light-storing fluorescent powder of sulfur compounds with a radioactive substance added thereto is capable of emitting light for a prolonged period of time, but the use of radioactive substances is internationally banned due to a possible radiation induced damage to the human body and environmental pollution.

In the early 1990s, a light-storing fluorescent powder containing an alkaline earth metal aluminate as a main component was proposed. As an alkaline earth metal, Eu is used. A light-storing fluorescent material with aluminate activated with Eu is advantageous in the fact that it exhibits a high emission intensity, emits light for a prolonged time, namely more than 24 hours, is chemically stable, has excellent durability, has a long lifetime of use, and therefore is widely used. For example, it is applied to such as fluorescent ink, fluorescent paint, fluorescent plastic, fluorescent glass, fluorescent fabric, ornamental products and low-intensity light sources.

A light-storing fluorescent powder comprised of the alkaline earth metal aluminate is a solid powder obtained by mixing α-Al₂O₃ with several required raw compositions and reacting the mixture at a high temperature of 1300° C. or higher. α-Al₂O₃ is significantly chemically stable so that it is not reacted with an alkaline earth metal unless the temperature is sufficiently high, does not generate monoclinic aluminate unless it has been reacted at a high temperature, and has an activator made of lanthanoid metal elements such as Eu₂O₃ introduced into crystals, thereby forming an emission center and a lattice imperfection. This highly rigid product cannot be turned into powder with a particle size of tens of micrometers unless it is subjected to intensive grinding treatment.

However, an activation energy is absorbed by crystal imperfection formed by the grinding so that light intensity declines. The light intensity is rapidly decreased when the particle size is decreased to 10μ or smaller, and light emission becomes weak when the particle size is decreased to 3μ or smaller, thus making it hard to be applied to actual use. Where a light-storing fluorescent powder is used such as in fluorescent ink for offset printing, fluorescent toner for an electronic copying machine and dye for dying fabric, an extreme-fine particle powder is required. It was not possible to obtain a fine particle powder having a sufficient emission intensity as long as a light-storing fluorescent powder of the conventionally-known alkaline earth metal aluminate is used.

On the other hand, when positive bivalent ions and positive trivalent ions in a light-storing fluorescent powder of an alkaline earth metal aluminate act as an activator, the light-storing fluorescent powder emits light of a completely different spectrum. In the alkaline earth metal aluminate, only bivalent Eu ions can form a lattice imperfection. When a light-storing fluorescent material is manufactured, positive trivalent Eu₂O₃ is generally added as an Eu-ion source, mixed and heated to a high temperature. It is necessary to reduce positive trivalent Eu to positive bivalent Eu during the heat reaction. Accordingly, this solid-phase reaction must be made under reducing atmosphere, and the reducing yield from positive trivalent Eu to positive bivalent Eu determines the quality of a light-storing fluorescent material. According to a conventional process, the reaction is made in a nitrogen gas flow containing about 5% of hydrogen gas, thereby achieving reduction of Eu ions. This reaction must be made in a sealed container and therefore involves a troublesome operation, causing increased manufacturing costs and making a light-storing fluorescent material hard to be manufactured in mass production.

Therefore, the present applicant disclosed in Japanese Patent Application No. Hei-10-185688 (Official Gazette of Japanese Patent Application Laid-open No. 2000-1672) that, as a light-storing fluorescent material of an alkaline earth metal aluminate having Eu as a main activator, AlCl₃, SrCl₂, BaCl₂, Eu₂O₃, Dy₂O₃ and H₃BO₃ are used as raw materials; the above chloride solution is mixed and reacted with ammonium-ion-containing solution to produce precipitate; the precipitate is dried to produce a fine particle powder; the fine particle powder is fired at high temperature under reducing atmosphere; and the fired fine particle powder is ground, thereby producing a light-storing fluorescent fine particulate material with extreme-fine particle size that exhibits a high emission intensity, emits light for a prolonged time and has excellent durability.

On the other hand, as described above, when a fine powder of a light-storing fluorescent material is to be applied such as to fluorescent ink, fluorescent paint, fluorescent plastic, fluorescent glass and fluorescent fabric, a fine powder with a constant particle size is required, and spherical particles are preferable in order to produce a fine powder with a narrow range of the particle size distribution.

However, those obtained by grinding a solid light-storing fluorescent material following the above conventional process are hard to produce spherical particles and therefore cannot provide sharp particle size classification having a narrow range of the particle size distribution.

In such a case where a light-storing fluorescent fine-powder is added to synthetic resin and the resultant is injection molded, the shape of the fine powder greatly affects on the workability of resin. A fine powder produced in the conventional process by grinding a highly rigid light-storing fluorescent material having alumina as a main component causes a synthetic-resin injection molding machine to be worn away at an early stage and therefore is hard to be used. Therefore, there is a demand in the market for a light-storing fluorescent fine powder that has a good workability such as when it is added to synthetic resin and injection molded.

Accordingly, it is an object of the present invention to provide a light-storing fluorescent powder that exhibits a high emission intensity, emits light for a prolonged time, has excellent durability, has extremely small particle size, and is unlikely to deteriorate its workability even when synthetic resin is added thereto.

It is another object of the present invention to provide a process of manufacturing a light-storing fluorescent powder of fine particle with an excellent quality in a remarkably simple manner.

### SUMMARY OF THE INVENTION

In order to achieve the above object, the present inventors repeatedly made intensive studies and found that a light-storing fluorescent spherical powder produced by heating a light-storing fluorescent powder or a light-storing fluorescent material to high temperature exhibits a high emission intensity, emits light for a prolonged time, has excellent durability and is unlikely to deteriorate its workability by no means even when it is added to synthetic resin, in comparison with a powder produced by grinding a light-storing fluorescent solid, and hence achieved the present invention.

In summary, according to the present invention, there is provided a light-storing fluorescent spherical powder that contains an alkaline earth metal aluminate as a main component and a transition metal element such as lanthanoid as an activator, in which the powder comprises a spherical powder.

According to another aspect of the present invention, there is provided a process of manufacturing a light-storing fluorescent spherical powder that includes preparing as a raw material a light-storing fluorescent powder that has been previously synthesized or a light-storing fluorescent precursor powder that has been produced by pre-reaction of a synthetic raw material of a light-storing fluorescent material, and passing the aforesaid raw material through a region heated to a temperature higher than a melting point of a light-storing fluorescent material, thereby forming the raw material into spherical shape.

### BRIEF DESCRIPTION OF THE DRAWINGS

FIG. 1 is a schematic view illustrating an example of a machine for manufacturing a light-storing fluorescent spherical powder of the present invention.

FIG. 2 is a photograph taken by an electron microscope, in which “a” represents a light-storing fluorescent powder produced by a conventional process and “b” represents a light-storing fluorescent spherical powder produced as an embodiment of the present invention.

### BEST MODE FOR CARRYING OUT THE INVENTION

In the present invention, as a light-storing fluorescent material for use, a fine powder produced by grinding various conventional light-storing fluorescent solid materials can be used. It is possible to use various conventional light-storing fluorescent materials, each contains an alkaline earth metal aluminate as a main component and has a transition metal element such as lanthanoid as an activator introduced therein, which activator generates a trap of an electron orbit for light-storing and occurrence of light emission.

The particle size of a light-storing fluorescent spherical fine powder of the present invention is preferably 1-100μ and more preferably 1-3μ. Where the particle size is 1μ or smaller, it is difficult to exhibit the light emitting capability. Where the particle size is 100μ or larger, it is excessively large, thus limiting the applied field thereof as a light-storing fluorescent powder. The particle size is preferably 3μ or smaller in order to use the powder such as in fluorescent ink for offset printing, fluorescent toner for an electronic copying machine and dye for dying fabric.

In the above conventional light-storing fluorescent material, by forming such fine powder into a spherical fine powder, it is possible to improve its inherent light emitting capability, as well as improving workability and handling ability in adding the powder to synthetic resin or printing ink.

As a manufacturing raw material used in a process of manufacturing a light-storing fluorescent material of the present invention, it is possible to use as a raw material a light-storing fluorescent fine powder produced by grinding a material previously synthesized as a light-storing fluorescent solid material. Or, it is possible to use as a raw material a precursor raw material of a stage previous to the manufacturing of a light-storing fluorescent material by heating and firing, in which the precursor raw material has yet no light storing capability in this stage and can be produced by mixing together raw materials required for synthesizing a light-storing fluorescent material and causing pre-reaction of the mixture.

In the manufacturing process of the present invention, these raw materials are passed through a region heated to a temperature higher than the solid's melting point so as to be molten into a spherical fine powder. The region heated to a temperature higher than the melting point can be provided by direct-current plasma jet of non-transfer type or transfer-type, high-frequency induction heating plasma, arc heating, a combustion gas burner, or other known techniques.

It is necessary to adjust heating atmosphere to reducing atmosphere, oxidizing atmosphere or inert gas atmosphere depending on the components of a light-storing fluorescent material, and accordingly it is necessary to select a heating technique and a heating gas for heating to the solid's melting temperature. For example, for a light-storing fluorescent material for which oxidizing atmosphere is preferable, it is possible to employ a technique to heat it in a plasma flame of air. For a light-storing fluorescent material for which reducing atmosphere is required (e.g., those having a rare earth element such as Eu and Dy as an activator), it is possible to employ a technique to use hydrogen or a mixed gas of an inert gas such as argon and hydrogen as a plasma gas, or a technique to inject raw materials of a light-storing fluorescent material into a plasma flame of an inert gas such as argon together with a carrier gas containing a reducing gas such as hydrogen.

In a technique to feed a raw powder into a region heated to a temperature higher than the solid's melting point, it is possible to use either a technique to as described above make the raw materials flow in the carrier gas and then blow a plasma flame into them for mixing together the same, a technique to mix a raw fine powder in a plasma carrier gas so as to cause a transfer-type plasma, or any other known techniques.

As a light-storing fluorescent material of the light-storing fluorescent spherical, fine particle powder of the present invention, it is possible to employ all the known light-storing fluorescent materials. Of them, it is preferable to use a light-storing fluorescent material comprising an alkaline earth metal aluminate with EU as a main activator, having the following general formula.
(A_{1-z-y}DₓE_{y})O.a(G_{1-z}H_{z})₂O₃
(wherein A is one element or two or more elements selected from the group consisting of Mg, Ca, Sr and Ba of alkaline-earth metals and Zn of a bivalent metal, D is Eu as an activator, E is one element or two or more elements selected from the group consisting of Dy, Nd, Ho, Er, Tm, Yb and Lu of lanthanoids s co-activators and the group consisting of Mn, Zr, Nb, Ti, Sb, Li, Ge, In and W of a transition metal, and G is Al of mother crystal, and H is B or Ga of mother crystal, and x, y, z and a are respectively numbers within the following ranges:
0.0001<x<0.5
0.0001<y<0.3
0.0001<z<0.5
1.5<a<3.0.

According to one example of processes for manufacturing a light-storing fluorescent spherical, fine particle powder, as raw materials, it is possible to use AlCl₃.6H₂O as the starting material of the Al component, SrCl₂.6H₂O as the starting material of the Sr component, TiCl₃ as the starting material of the Ti component, and Eu₂O₃, Dy₂O₃ and H₃BO₃ respectively as the starting materials of the Eu, Dy and B components, respectively.

Preferably, the mole ratio between SrCl₂ and AlCl₃ as the starting materials is 1:1.5-1:5, the mole ratio between Eu₂O₃ and Dy₂O₃ is 1:1-1:2, the mole ratio between SrCl₂ and Eu₂O₃ is 1:0.001-1:0.02, and the mole ratio between SrCl₂ and TiCl₃ is 1:0.0001-1:0.01.

Where a precursor material is used as a raw material, it is possible to prepare a solution A by dissolving Eu₂O₃ and Dy₂O₃ of the starting materials in water, prepare a solution B by dissolving H₃BO₃, AlCl₃.6H₂O, SrCl₂.6H₂O and TiCl₃ in water, mixing the solutions A and B together, feeding the mixture into pure water of 80° C. for reaction, thereby producing precipitate, and filtering out and drying the precipitate, thus synthesizing a precursor material useable as a raw material.

When it is necessary to adjust the particle size of a light-storing fluorescent spherical particle powder, the adjustment may be achieved by adjusting the agitating speed or the feeding speed in a step of feeding the mixed solutions A and B into the pure water. For example, where the mixed solutions are fed into the pure water while agitating the pure water at high speed, it is possible to produce a light-storing fluorescent spherical particle powder with small diameter. Where the mixed solutions are fed into the pure water while agitating the pure water at low speed, it is possible to produce a light-storing fluorescent spherical particle powder with large diameter. Accordingly, it is possible to produce a light-storing fluorescent spherical particle powder with a particle size of 1-100μ, which is suitable in the present invention, by adjusting such as the agitating speed in preparation of the precursor material.

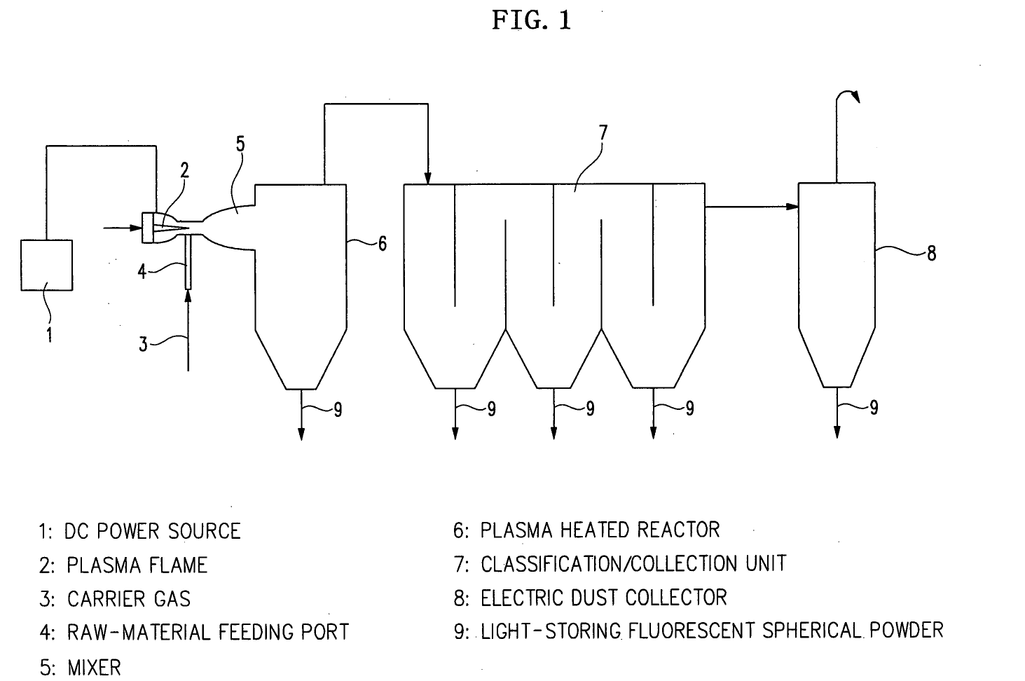

While illustrating one example of an apparatus for manufacturing a light-storing fluorescent spherical particle powder of the present invention in FIG. 1, a description will be made for a manufacturing process using the illustrated apparatus. In this example, as a means for producing a heated region for manufacturing a light-storing fluorescent fine-powder, a DC argon plasma flame is used. The reference numeral 1 represents a DC power source, and respectively 2: a plasma flame, 3: a carrier gas, 4: a raw-material feeding port, 5: a venturi mixer, 6: a plasma heated reactor, 7: a classification/collection unit, 8: an electric dust collector and 9: a light-storing fluorescent spherical powder. The venturi mixer 5 has a nozzle, through which the precursor material is fed into the venturi mixer 5 together with a carrier gas comprising argon and hydrogen, allowing themselves to be mixed with the plasma flame 2 of argon gas. In the plasma flame 2 of high temperature, the precursor material is heated and reacted under the reducing atmosphere containing hydrogen, thereby synthesizing a light-storing fluorescent material in fine powder form, and at the same time melting the same by heating at high temperature and hence making a spherical fine powder by surface tension.

Then, a gas, which has come out of the plasma heated reactor 6 and contains a fine powder, is brought into the classification/collection unit 7 at which particles are classified in three classes and respectively collected. Further, a gas containing a fine powder with particles of minimum diameter is brought into the electric dust collector 8 and the residual fine powder is collected.

Now, the description will be made for an embodiment of the process of manufacturing a light-storing fluorescent fine particle powder of the present invention, while not intended to limit the present invention.

### EXAMPLE 1

| | |
|---|---|
| SrCl₂.6H₂O | 269 g |
| AlCl₃.6H₂O | 683.2 g |
| TiCl₃ | 1.01 g |
| H₃BO₃ | 30.0 g |

The above are dissolved in 3000 ml of ion-exchange water, thereby preparing an aqueous solution which is designated as a solution A.

Then, the below are dissolved in hydrochloric acid, thereby preparing a solution B.

| | |
|---|---|
| Eu₂O₃ | 2.0 g |
| Dy₂O₃ | 2.0 g |

The solution B was heated to evaporate excessive hydrochloric acid and thus remove the same. Then, the solution B was fed into the solution B and these were agitated. Thus, a solution C was prepared.

540 g of (NH₄)₂CO₃ was dissolved in 2000 ml of ion-exchange water. Thus, a solution D was prepared. The solution D was heated to 80° C. and vigorously agitated while adding the solution C thereto and kept them at 80° C. for 1 hour. They were once agitated and allowed to stand to cool. Precipitate produced was filtered out, dried with heat and then ground. Thus, a precursor material was prepared. This precursor material was fed through the raw-material feeding port 4 together with an argon-hydrogen mixture gas. They were mixed in the plasma flame 2 by the mixer 5 and heated by plasma in the plasma heated reactor 6 to about 1800° C. Thus, the light-storing fluorescent spherical powder 9 was produced.

The light-storing fluorescent spherical powder 9 thus produced had particles each formed into spherical shape and was a fine powder with even particle size having a narrow range of the particle size distribution.

### EXAMPLE 2

As a raw material, a light-storing fluorescent fine powder that was produced by previously synthesizing a light-storing fluorescent solid and grinding the same. Specifically, the following powders were mixed:

| | | |
|---|---|---|
| Al₂O₃ | 3300 | g |
| SrCO₃ | 5000 | g |
| Eu₂O₃ | 120 | g |
| Dy₂O₃ | 150 | g |
| SiO₂ | 0.05 | g |
| NiCO₃ | 0.009 | g |
| H₃BO₄ | 600 | g |

They were mixed together evenly for 3 hours by a ball mill at room temperature and then temporarily fired at 1200° C. The thus produced temporarily fired substance was ground into fine particles, and these were used as a raw material for plasma spraying. The plasma spraying was performed with Ar gas (pressure: 5.17×10⁵ Pa, flow rate: 1.0 L/s), H₂ gas (pressure: 3.45×10⁵ Pa, flow rate: 0.25 L/s), current of 600 A, and voltage of 60 V.

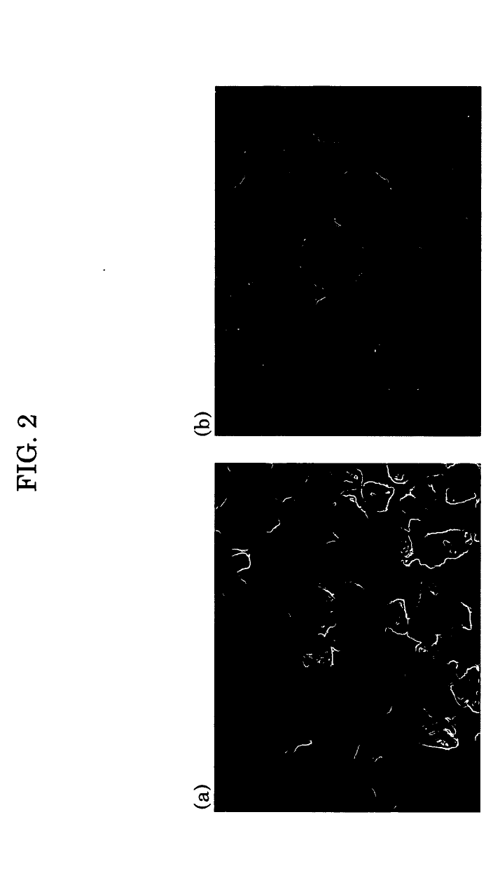

FIG. 2 is a photograph taken by an electron microscope, illustrating a light-storing fluorescent spherical powder of the Example 2 and a light-storing fluorescent powder produced by a conventional process as a comparative example.

As is apparent from FIG. 2, a light-storing fluorescent spherical powder of the present invention (FIG. 2(b)) is completely different from a conventional powder (FIG. 2(a)), showing fine particles each remarkably resembling a spherical shape

A light-storing fluorescent spherical powder of the present invention is a fine powder with each particle having a spherical shape and even particle size, and therefore when it is used as a light-storing fluorescent coloring agent of synthetic resin, remarkable workability and handling ability are produced.

With the process of manufacturing a light-storing fluorescent spherical powder of the present invention, the manufacturing process is short and continuous manufacturing can be made. Also, grinding after the firing is not required. Thus, it is possible to produce a light-storing fluorescent spherical, fine particle powder at low cost, while keeping the direct quality constant.

A light-storing fluorescent powder produced in the present invention has a high light intensity, emits light for a prolonged time and has excellent durability. Since the light-storing fluorescent powder is a spherical, fine particle powder of remarkably small particles, it can be properly used in such as in fluorescent ink for offset printing or ink-jet printing, fluorescent toner for an electronic copying machine, dye for dying fabric, and fluorescent coloring agent for synthetic resin pellets, synthetic resin film or paint.

1. A light-storing fluorescent spherical powder comprising an alkaline earth metal aluminate as a main component and a transition metal element such as lanthanoid as an activator, in which said powder comprises a spherical powder.

2. A light-storing fluorescent spherical powder according to claim 1, wherein said light-storing fluorescent spherical powder comprises a fine particle powder with a particle size of 1-100μ or smaller.

3. A light-storing fluorescent spherical powder according to any one of claim 1, wherein said light-storing fluorescent spherical powder has the general formula:
(A_{1-z-y}DₓE_{y})O.a(G_{1-z}H_{z})₂O₃
Wherein A is one element or two or more elements selected from the group consisting of Mg, Ca, Sr and Ba of alkaline-earth metals and Zn of a bivalent metal, D is Eu as an activator, E is one element or two or more elements selected from the group consisting of Dy, Nd Ho, Er, Tm, Yb and Lu of lanthanoids as co-activators and the group consisting of Mn, Zr, Nb, Ti, Sb, Li, Ge, In and W of a transition metal, and G is Al of mother crystal, and H is any one of B and Ga of mother crystals, and x, y, z and a are respectively numbers within the following ranges:
0.0001<x<0.5
0.0001<y<0.3
0.0001<z<0.5
1.5<a<3.0.

4. A process of manufacturing a light-storing fluorescent spherical powder comprising preparing as a raw material a light-storing fluorescent powder that has been previously synthesized or a light-storing fluorescent precursor powder that has been produced by pre-reaction of a synthetic raw material of a light-storing fluorescent material, and passing said prepared raw material through a region heated to a temperature higher than a melting point of a light-storing fluorescent material, thereby forming said raw material into spherical shape.

5. A process of manufacturing a light-storing fluorescent spherical powder according to claim 4, wherein said region heated to a temperature higher than said melting point comprises a plasma region.

6. A process of manufacturing a light-storing fluorescent spherical powder according to claim 5, wherein said plasma region is provided by any one of direct-current plasma jet of non-transfer type, direct-current plasma jet of transfer type, high-frequency induction heating plasma, plasma generated by arc heating, and the like.

7. A light-storing fluorescent spherical powder according to any one of claim 2, wherein said light-storing fluorescent spherical powder has the general formula:
(A_{1-z-y}DₓE_{y})O.a(G_{1-z}H_{z})₂O₃
Wherein A is one element or two or more elements selected from the group consisting of Mg, Ca, Sr and Ba of alkaline-earth metals and Zn of a bivalent metal, D is Eu as an activator, E is one element or two or more elements selected from the group consisting of Dy, Nd Ho, Er, Tm, Yb and Lu of lanthanoids as co-activators and the group consisting of Mn, Zr, Nb, Ti, Sb, Li, Ge, In and W of a transition metal, and G is Al of mother crystal, and H is any one of B and Ga of mother crystals, and x, y, z and are respectively numbers within the following ranges:
0.0001<x<0.5
0.0001<y<0.3
0.0001<z<0.5
1.5<a<3.0.
